(19) United States
(12) Patent Application Publication
(10) Pub. No.: US 2008/0111088 A1
(43) Pub. Date: May 15, 2008

(54) SELF-CONTAINED RELIEF VALVE ADJUSTMENT DEVICE

(75) Inventors: James K. Simonelli, Buford, GA (US); Laney A. Seabolt, Commerce, GA (US)

Correspondence Address: CAESAR, RIVISE, BERNSTEIN,;COHEN & POKOTILOW, LTD., 11TH FLOOR, SEVEN PENN CENTER, 1635 MARKET STREET, PHILADELPHIA, PA, 19103-2212, US

(73) Assignee: ROPER PUMP COMPANY, Commerce, GA (US)

(21) Appl. No.: 11/937,875

(22) Filed: Nov. 9, 2007

Related U.S. Application Data
(60) Provisional application No. 60/865,298, filed on Nov. 10, 2006.

(51) Int. Cl. F16K 17/06; F16K 31/126

(52) U.S. Cl. 251/60

(57) ABSTRACT

A self-contained non-liquid contacting relief valve adjusting device is easily disassembled from a relief valve preferably by removing a clamp band without the use of wrenches or special tools and separating the device from the relief valve. The adjusting device retains the preset relief valve adjustment when removed, and eliminates the requirement for readjustment of the relief valve by retaining the spring compression in the adjusting device. This feature enables the relief valve adjusting device to be set one time and to retain that setting throughout the life of the relief valve regardless of how many times the relief valve is disassembled for cleaning.

### CROSS-REFERENCE TO RELATED APPLICATIONS

This utility application claims the benefit under 35 U.S.C. §119(e) of Provisional Application Ser. No. 60/865,298 filed on Nov. 10, 2006 entitled SELF-CONTAINED RELIEF VALVE ADJUSTMENT DEVICE and whose entire disclosure is incorporated by reference herein.

### BACKGROUND OF THE INVENTION

1. Field of Invention

This invention is related generally to devices for regulating the adjustments or settings of relief valves, and more particularly, to self-contained adjustment devices for integral relief valves used in sanitary pumps.

2. Description of Related Art

When using a relief valve on a sanitary pump, it is often desirable to disassemble the relief valve for cleaning purposes as often as several times each day. Disassembly for cleaning purposes should be accomplished as quickly and easily as possible. Currently, the tools required for the disassembly are limited to a few basic tools.

Typically, liquid contact areas of a sanitary pump have to be disassembled and cleaned on a daily basis. Unfortunately, the cleaning of the liquid contact areas of a sanitary pump can be very time consuming if the relief valve adjustment parts have to be disassembled. During the disassembly, the compression or tension on the spring must be released prior to removing the relief valve adjustment device to clean the relief valve. Releasing the compression on the spring during disassembly results in additional time and work because the spring compression on the relief valve must be properly reset. That is, whenever the prior art relief valve adjustment parts are removed for cleaning, the relief valve must be reset when reassembling.

Moreover, the known relief valve adjustment devices require resetting and testing every time the relief valve is reassembled after cleaning. Technically, this requires running the pump and making adjustments as required to properly set the relief valve.

It would be a benefit to eliminate the requirement for readjustment of the relief valve by retaining the spring compression in the device assembly. All references cited herein are incorporated herein by reference in their entireties.

### BRIEF SUMMARY OF THE INVENTION

The preferred embodiments include a self-contained non-liquid contacting relief valve adjusting device that is easily disassembled from the relief valve by removing the clamp band without the use of wrenches or special tools and separating the device from the relief valve. The device retains the preset relief valve adjustment when removed, and eliminates the requirement for readjustment of the relief valve by retaining the spring compression in the device assembly.

This feature enables the relief valve adjusting device to be set one time and to retain that setting throughout the life of the relief valve regardless of how many times the relief valve is disassembled for cleaning.

The clamp band is a commercially available part that is typically used to connect sanitary pipes and fittings. However, in the preferred embodiments of the invention, the clamp band—sometimes referred to as a removable “V-clamp”—is used to connect two assemblies of a pump. This allows a user to remove the relief valve adjusting device from the relief valve without the need of special tools. By loosening one fastener of the clamp band, the user can remove the entire relief valve adjusting device in one piece. While not being limited to a particular theory, the clamp band is used to couple a self-contained relief valve adjustment device to a pump assembly that, when removed, allows a relief valve cap and associated relief valve adjustment parts to be removed from a pump without having to change or relieve the spring pressure or relief valve setting prior to removal from the pump.

In an exemplary embodiment, a self-contained non-liquid contacting relief valve adjustment device is removable from a relief valve assembly for readily available access to fluid contacting relief valve elements within the relief valve assembly. The self-contained non-liquid contacting relief valve includes a housing, a compression spring, a plunger, a retaining member (e.g., a retaining ring, a c-clamp, a fitted collar, a retainer plate, a threaded ring, collar or plate) and an adjusting screw. The housing has a closed end and an open end defining a bore. The compression spring is disposed in the bore of the housing, with the compression spring coupled at its first end to a spring guide at the closed end of the housing. The plunger is slidingly received in the bore at the open end of the housing, with the plunger abutting a second end of the compression spring to house the compression spring within the housing between the plunger and the spring guide, and to close liquid communication at the open end between the compression spring and the fluid contacting relief valve elements contained in the relief valve assembly. The retaining member is attached to the bore at the open end of the housing, with the retaining member confining the plunger within the bore and keeping the plunger from falling out of the housing. The adjusting screw includes a threaded shank extending through the closed end of the housing and coupled to the spring guide. The adjusting screw is threadingly received by the housing to act on the spring guide and adjust a compression of the compression spring and therefore set a pressure load in accordance with rotation of the adjusting screw against the housing. It is important to note that the retaining member maintains the pressure load regardless of an attachment to the relief valve assembly.

In another exemplary embodiment of the invention, the relief valve adjusting device includes a relief valve cover that houses the relief valve spring, two spring guides, an adjusting screw, an adjusting screw locknut and a retaining ring. The relief valve cover houses the relief valve spring, the spring guides, and the retaining ring. The adjusting screw is installed through the adjusting screw locknut and into the top end of the relief valve cover. The first spring guide is fitted onto the end of the adjusting screw that protrudes into the relief valve cover. One end of the spring is fitted to the first spring guide. The second spring guide is fitted to the other end of the spring. A retaining ring is installed into an annular groove in the inside diameter of the relief valve cover.

When installed to the relief valve, the relief valve pushes the second spring guide away from the retaining ring and adds a spring load on the relief valve poppet. The retaining ring is not carrying any load while the relief valve adjusting device is installed on the pump. The relief valve adjusting device is preferably attached to the relief valve by a clamp band, threaded fasteners or other equivalent fastening devices. When attached, the relief valve can be adjusted, for example, by turning the adjusting screw to an appropriate position and tightening the adjusting screw locknut to hold the adjusting screw in the appropriate position. When the relief valve adjustment device is removed from the relief valve, the second spring guide, which is carrying the spring load, rest against the retaining ring. This, in turn, eliminates the need to remove the adjusting screw load on the relief valve spring prior to disassembly of the relief valve for cleaning or removing the fluid contacting parts of the relief valve.

### BRIEF DESCRIPTION OF SEVERAL VIEWS OF THE DRAWINGS

The invention will be described in conjunction with the following drawings in which like reference numerals designate like elements, and wherein:

FIG. 1 is an isometric view of an exemplary embodiment of the relief valve adjusting device;

FIG. 2 is a sectional view of the exemplary relief valve adjusting device taken substantially along the centerline of FIG. 1;

FIG. 3 is an exploded view of the exemplary relief valve adjusting device;

FIG. 4 is another isometric view of the relief valve adjusting device detached from a mating assembly; and

FIG. 5 is a sectional view of the exemplary relief valve adjusting device coupled to the mating assembly.

### DETAILED DESCRIPTION OF THE PREFERRED EMBODIMENTS

The relief valve adjustment device allows a relief valve cap with associated adjustment parts to be removed from a pump without having to change or relieve the spring pressure or relief valve setting prior to removal of the spring from the pump. In a preferred embodiment, the relief valve cap and adjustment parts are part of a single assembly which can be removed and reattached without resetting the relief valve. The self-contained relief valve adjustment includes a relief valve cap housing a compression spring disposed in the bore of the relief valve cap. A first end of the spring abuts a spring guide at an open end of the relief valve cap. The spring guide is confined to the bore by a retaining ring that closes the open end and keeps the spring guide from falling out of the relief valve cap. The second or opposite end of the spring is coupled to an adjusting screw via a washer that adjusts the compression of the spring in accordance with rotation of the adjusting screw that is threadingly received by the relief valve cap. A lock nut is mounted on the threaded shank of the adjusting screw and rotates against the relief valve cap to lock the adjusting screw in place. With the self-contained relief valve adjustment removed, the liquid contacting relief valve located in the face plate assembly of the pump is easily accessible for cleaning.

In another preferred embodiment, a clamp band is used in a non-typical way to attach the relief valve adjustment assembly to the relief valve. In this manner the band can be removed without the need for specific use tools such as wrenches.

With the relief valve adjusting device removed, the relief valve parts can be slipped out and the entire relief valve cleaned. The relief valve adjusting device remains assembled with the relief valve adjustment unaffected. The relief valve adjustment device is not a product contact assembly and therefore does not require disassembly for cleaning purposes. That is, the internal parts of the adjustment device are not liquid contact areas of, for example, a sanitary pump, and thus does not have to be disassembled and cleaned, in contradistinction to known liquid contact relief valve parts.

The preferred relief valve adjusting device includes a spring load retaining device that has a retaining ring, bolted retainer plate, pinned retainer plate or any other retaining member to retain the spring pressure while the device is removed from the relief valve for cleaning. When the cleaning is completed, the relief valve parts can be slipped back into position and the relief valve adjusting device re-attached using the clamp band. Resetting the relief valve adjustment is not necessary since the original adjustment set by the adjusting screw has not been changed. With this device, the compression on the relief valve adjustment spring does not have to be released prior to removing the device from the relief valve, thereby saving time and eliminating the possibility of an inexperienced person resetting the relief valve adjustment improperly.

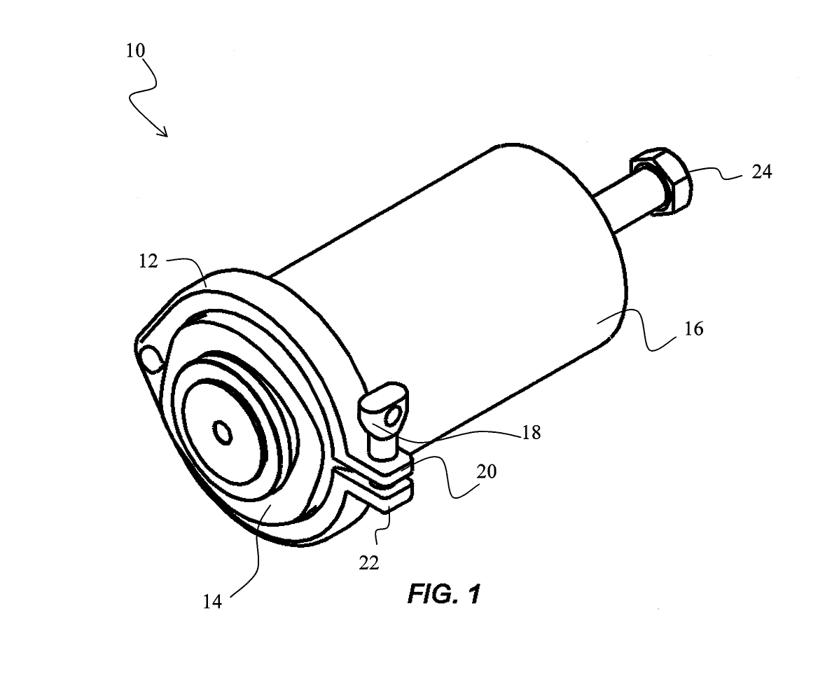

An exemplary relief valve adjusting device 10 according to a preferred embodiment of the invention is shown in FIGS. 1-5. FIG. 1 depicts the relief valve adjusting device 10 (also referred to as “adjusting device”) with a clamp band 12 used to connect the relief valve adjusting device to a mating assembly 14 (e.g., a relief valve assembly). The relief valve adjusting device 10 includes a housing 16 coupled to the mating assembly 14 via the clamp band 12, and is separable from the mating assembly 14 upon release of the clamp band. Preferably, the clamp band 12 includes a pin 18 and opposing first and second ends for receiving the pin. While not being limited to a particular theory, the pin 18 is threadingly engagable with the second end 22 of the clamp band to open and close the clamp band (and release or couple the adjusting device 10 and the mating assembly 14), as readily understood by a skilled artisan. Of course other known approaches are also available for opening and closing the clamp band 12 and are considered within the scope of the invention.

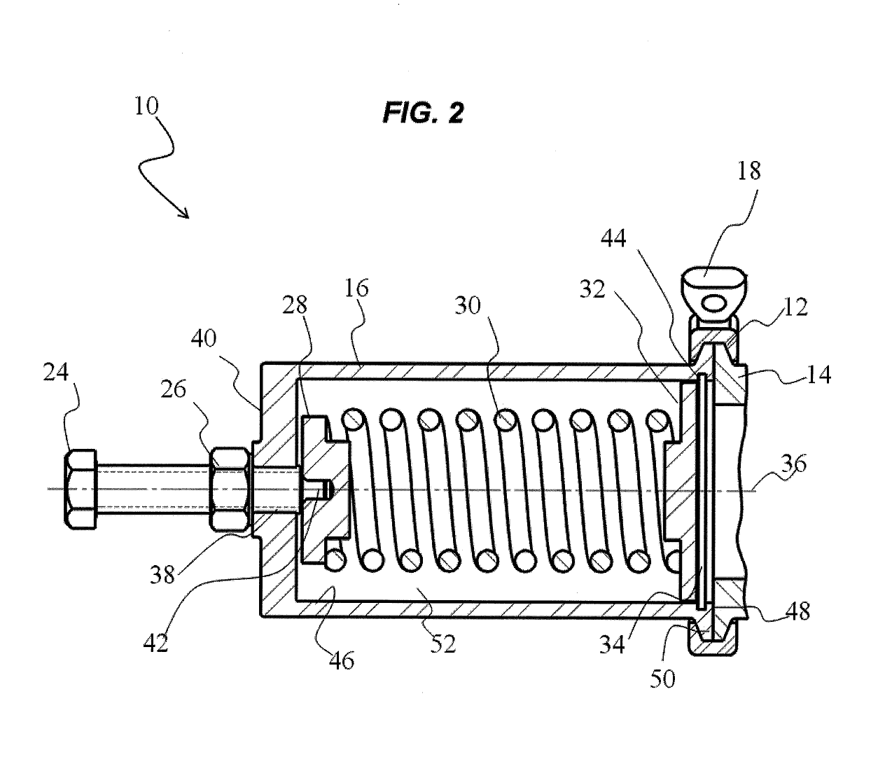

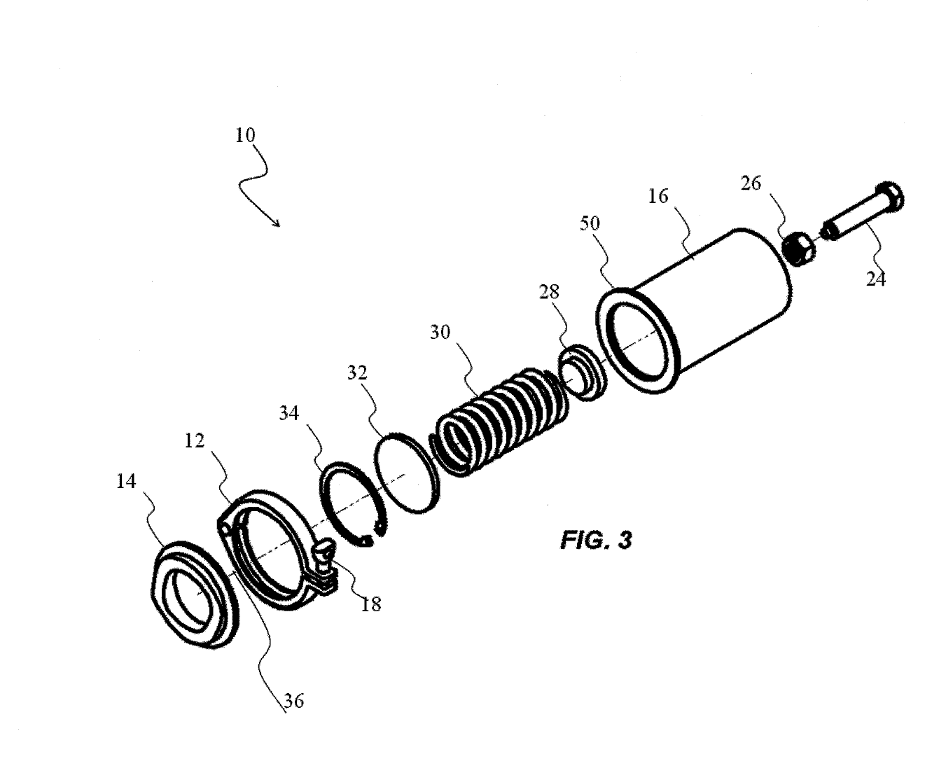

FIG. 2. is a cross sectional view of the relief valve adjusting device 10, and FIG. 3 depicts the adjusting device in an exploded view. As can best be seen in FIGS. 2 and 3, the relief valve adjusting device 10 includes the housing 16, an adjusting screw 24, a locknut 26, a spring guide 28, a compression spring 30, a plunger 32, and a retaining ring 34; all shown positioned along a centerline 36 of the adjusting device. The housing 16 includes a domed end 40, an annular groove 44, an interior cylindrical wall 46, an open end 48 opposite the domed end and defining a bore 52, and a flanged rim 50 at the open end, as will be described in greater detail below.

Referring to FIG. 2, the adjusting screw 24 is installed through the locknut 26 and through an opening 38 at a domed end 40 of the housing 16, preferably via threaded engagement. The spring guide 28 is fitted onto an inserted end 42 of the adjusting screw 24 that protrudes into the housing 16. Together the adjusting screw 24 and the spring guide 28 form an exemplary adjusting means for setting a pressure load or tension setting of a biasing means. The compression spring 30 is one of several known biasing means, and is disposed in the bore 52 of the housing 16. Preferably, a first end of the compression spring 30 is fitted against the spring guide 28, and a second end of the spring is fitted against the plunger 32.

The plunger 32 is a generally disc shaped piston having a circumference substantially the same or slightly less than a circumference of the interior cylindrical wall 46 to allow the plunger to slide within the interior cylindrical wall and seal the open end 48 to fluid bypass. That is, the plunger operates as a sealing means slidingly received in the bore 52 at the open end 48 and thus prevents fluid exposure to the spring 30 and the spring guide 28 through the open end 48 of the housing 16. The plunger 32 is fitted against the second end of the spring 30 opposite the spring guide 28 and is urged away from the spring guide by the spring. Preferably the spring guide 28, the spring 30 and the plunger 32 are shaped to couple in a fitted engagement that maintains their relationship, as shown, for example in FIG. 2.

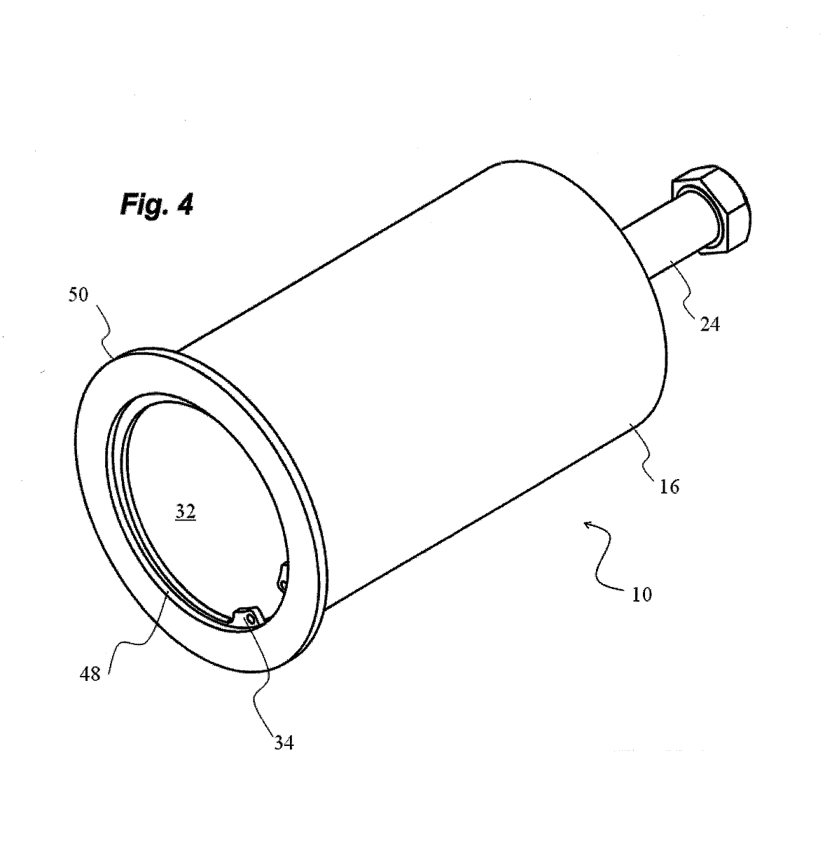

The retaining ring 34 is installed into the annular groove 44 located in the interior cylindrical wall 48 of the housing 16 proximate the open end 48. While not being limited to a particular theory, the retaining ring 34 is preferably a c-clip slotted to allow temporary depression of the ring during insertion into the open end, as can best be seen in FIG. 3. Once installed, the retaining ring 34 fits into the annular groove 44 and extends into the interior of the housing 16 for abutment against the plunger 32 to secure the urged plunger 32 inside the housing 16 and form the assembled adjusting device 10, as shown, for example in FIG. 4.

As described above, the retaining ring 34 is an exemplary retaining means attached to the bore 52 at the open end 48 of the housing 16. It is understood that the retaining ring 34 is a spring load c-clip and may be replace by any number of other retaining members including but not limited to a fitted collar, a bolted retainer ring or plate, a pinned retainer ring or plate or a retainer ring or plate held in place by tapered ring sitting in a groove or bolted in. Moreover, the annular groove 44 is understood to cover equivalent approaches to communicate with a retaining member to confine the plunger within the bore of the housing, to keep the plunger from falling out of the housing and to maintain a tension setting (e.g., pressure load) of the compression spring regardless of an attachment to the relief valve assembly. For example, the annular groove could include an inward facing threaded portion, and the retaining member could include an external threaded portion that threadingly engages the threaded portion of the annular groove to couple the annular groove with the retaining member.

Still referring to FIG. 2, moving the adjusting screw 24 further into the housing 16 increases a tension setting of the spring 30, and moving the adjusting screw out of the housing decreases the tension setting of the spring, as readily understood by a skilled artisan. Preferably the adjusting screw 24 is moved into and out of the housing 16 by rotating the adjusting screw threadingly engaged with the opening 38 of the housing. The locknut 26 when rotated against the domed end 40 secures the advancement of the adjusting screw in the housing 16 and maintains the tension setting of the spring 30. As such, the locknut 26 is an exemplary locking means for locking the adjusting screw in place.

The aforementioned elements of the adjusting device 10 are so assembled as to form a single unit to be bodily attached or detached without affecting the tension setting of the compression spring 30. The assembled relief valve adjusting device 10 is then ready for attachment to a mating assembly 14 (e.g., relief valve assembly), preferably by encircling mating parts of the adjusting device (e.g., the flanged rim 50) and the mating assembly with a clamp band 12 that includes the pin 18, and then by tightening the pin, for example, by turning the pin into the threaded second end 22 as readily understood by a skilled artisan. The assembled relief valve adjusting device 10 may also be separated from the mating assembly 14 as desired for access and cleaning of the liquid contacting parts within the mating assembly. Of course the adjusting device 10 does not require further disassembly for cleaning since it is not a liquid contacting part.

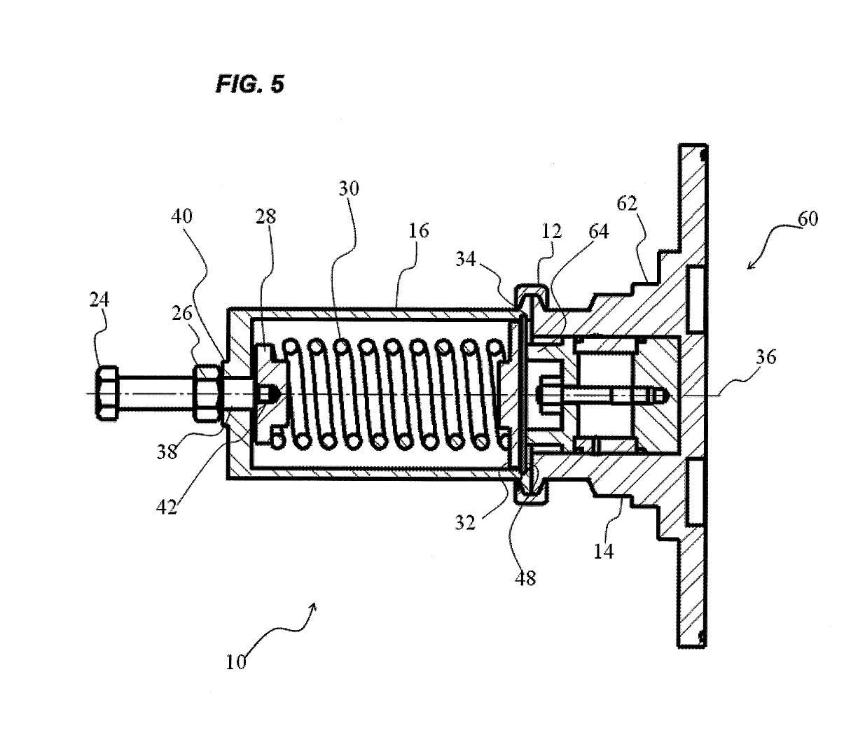

FIG. 5 discloses an exemplary assembled relief valve adjustment device 10 attached to a mating assembly 14, which, in this example, is a pump 60 having a liquid contacting faceplate assembly 62 including a relief valve poppet 64. Once the adjustment device 10 is removed from the pump 60, the relief valve poppet 64 in the faceplate assembly is easily accessible for cleaning.

As should be understood in light of the above disclosure, many other configurations are possible. For example, the clamp band 12 may be replaced by other structures for retention including but not limited to a bolted joint or screwed joint. In other words, the clamp band 12 is understood to be an exemplary clamping means for attaching the mating assembly 14 to the relief valve adjustment device 10, and the invention is not limited thereto. Moreover, in alternative embodiments of the invention, the relief valve adjusting screw 24 and locknut 26 may be replaced by any number of other approaches for spring compression adjustment including but not limited to shims or spacers behind the spring guide 28 to make the valve adjustment (e.g., spring tension setting) tamper proof from outside the relief valve adjustment device.

It is understood that the self-contained integral pressure relief valve adjusting device described and shown are exemplary indications of preferred embodiments of the invention, and are given by way of illustration only. In other words, the concept of the present invention may be readily applied to a variety of preferred embodiments, including those disclosed herein. While the invention has been described in detail and with reference to specific examples thereof, it will be apparent to one skilled in the art that various changes and modifications can be made therein without departing from the spirit and scope thereof. Without further elaboration, the foregoing will so fully illustrate the invention that others may, by applying current or future knowledge, readily adapt the same for use under various conditions of service.

What is claimed is:

1. A relief valve adjusting device, comprising:
a housing having a domed end and an open end defining a bore;
an adjusting screw having a first end extending through an opening of said domed end into the bore of said housing;
a compression spring coupled to said first end of said adjusting screw within the bore;
a plunger coupled to said compression spring opposite said adjusting screw and slidingly received within the bore, said plunger sealing said compression spring in the bore from liquid communication at said open end; and
a retaining member attached to said bore at said open end of said housing, said retaining member confining said plunger within said bore, keeping said plunger from falling out of the housing and maintaining a tension setting of said compression spring.

2. The relief valve adjusting device of claim 1, further comprising a connector for connecting to and disconnecting from said housing to a mating assembly, said retaining member maintaining the tension setting of said compression spring while said relief valve adjusting device is disconnected from said mating assembly.

3. The relief valve adjusting device of claim 2, wherein said mating assembly is a fluid pump having fluid contacting parts and said plunger prevents access of fluid from the pump to said compression spring.

4. The relief valve adjusting device of claim 2, said mating assembly including a relief valve assembly, said connector including a clamp band having a clamp band pin, said clamp band attaching said relief valve adjustment device to the relief valve assembly, said clamp band pin adapted to tighten or loosen the clamp band to secure or release the attachment between the relief valve assembly and said relief valve adjustment device.

5. The relief valve adjusting device of claim 1, said housing including an annular groove in said bore adjacent said open end, said retaining member including a retaining ring fitted into said annular groove and extending into the interior of said housing to abut said plunger within said bore and keep said plunger from falling out of said housing.

6. The relief valve adjusting device of claim 1, further comprising a spring guide fitted between said adjusting screw and said spring to maintain the coupling therebetween.

7. The relief valve adjusting device of claim 6, said adjusting screw threadingly received by said housing to act on said spring guide and adjust a compression of said compression spring and therefore set a pressure load in accordance with rotation of the adjusting screw against said housing, wherein said retaining member maintains the pressure load regardless of an attachment to a mating assembly at said open end.

8. The relief valve adjusting device of claim 1, further comprising a locknut threadingly engaged with said adjusting screw and abutting the domed end of said housing to secure the advancement of said adjusting screw in said housing and maintains the tension setting of said compression spring.

9. A self-contained non-liquid contacting relief valve adjustment device removable from a relief valve assembly for readily available access to fluid contacting relief valve elements within the relief valve assembly, comprising:
a housing having a closed end and an open end defining a bore;
a compression spring disposed in the bore of said housing, said compression spring coupled at its first end to a spring guide at the closed end of said housing;
a plunger slidingly received in said bore at said open end of said housing, said plunger abutting a second end of said compression spring to house said compression spring within said housing between said plunger and said spring guide, and to close liquid communication at said open end between said compression spring and the fluid contacting relief valve elements contained in the relief valve assembly;
a retaining member attached to said bore at said open end of said housing, said retaining member confining said plunger within said bore and keeping said plunger from falling out of the housing; and
an adjusting screw having a threaded shank extending through said closed end of said housing and coupled to said spring guide, said adjusting screw threadingly received by said housing to act on said spring guide and adjust a compression of said compression spring and therefore set a pressure load in accordance with rotation of the adjusting screw against said housing, wherein said retaining member maintains the pressure load regardless of an attachment to the relief valve assembly.

10. The self-contained non-liquid contacting relief valve adjustment device of claim 9, further comprising a lock nut mounted on the threaded shank of the adjusting screw adjacent said closed end of said housing opposite said bore, said lock nut being rotated against said housing to lock said adjusting screw in place.

11. The self-contained non-liquid contacting relief valve adjustment device of claim 9, further comprising a clamp band having a clamp band pin, said clamp band attaching the relief valve assembly to said relief valve adjustment device, said clamp band pin adapted to tighten or loosen the clamp band to secure or release the attachment between the relief valve assembly and said relief valve adjustment device.

12. The self-contained non-liquid contacting relief valve adjustment device of claim 9, said housing including an annular groove in said bore adjacent said open end, said retaining member including a retaining ring fitted into said annular groove and extending into the interior of said housing to abut said plunger within said bore and keep said plunger from falling out of said housing.

13. A self-contained non-liquid contacting relief valve adjustment device removable from a relief valve assembly for readily available access to fluid contacting relief valve elements within the relief valve assembly, comprising:
a housing having a closed end and an open end defining a bore;
biasing means disposed in the bore of said housing, said biasing means coupled to the closed end of said housing;
sealing means slidingly received in said bore at said open end of said housing, said sealing means abutting the biasing means and housing the biasing means within said housing between the closed end and the sealing means, the sealing means closing liquid communication at the open end between the biasing means and the fluid contacting relief valve elements contained in the relief valve assembly, the biasing means pushing the sealing means away from the closed end of said housing;
retaining means attached to said bore at said open end of said housing, said retaining means confining the sealing means within said bore and keeping the sealing means from falling out of the housing; and
adjusting means coupled to the biasing means, the adjusting means setting a pressure load of the biasing means, wherein the retaining means maintains the pressure load regardless of an attachment to the relief valve assembly.

14. The self-contained non-liquid contacting relief valve adjustment device of claim 13, further comprising locking means for locking the adjusting means in place.

15. The self-contained non-liquid contacting relief valve adjustment device of claim 13, further comprising connector means attaching the relief valve assembly to said relief valve adjustment device.
